(19) United States
(12) Patent Application Publication
(10) Pub. No.: US 2021/0101461 A1
(43) Pub. Date: Apr. 8, 2021

(54) SHROUD FOR A HEAVY-DUTY VEHICLE COMPONENT

(71) Applicant: Hendrickson USA, L.L.C., Schaumburg, IL (US)

(72) Inventor: Nicholas J. Giamati, Akron, OH (US)

(21) Appl. No.: 16/591,674

(22) Filed: Oct. 3, 2019

(51) Int. Cl. B60J 11/06

(52) U.S. Cl. CPC B60J 11/06

(57) ABSTRACT

A shroud for a heavy-duty vehicle component that includes structure enabling the component to be mounted and housed within an interior space of the shroud, such that the component is substantially enclosed and protected when the shroud is mounted on the heavy-duty vehicle frame. In one embodiment, the component is a valve of a pin release/locking system of a moveable subframe. The shroud enables mounting of the component in a location within the interior space of the shroud that provides relatively safe, sufficient clearance for components of a forward mounted down-stop employed in some axle/suspension systems depending from the heavy-duty vehicle frame. The shroud includes structure that enables the shroud to be temporarily attached to a heavy-duty vehicle moveable subframe during shipping at a location on the subframe so that the component and associated structure are within the longitudinal length of main members of the subframe.

### BACKGROUND OF THE INVENTION

### Field of the Invention

The disclosed subject matter relates generally to frames or subframes for heavy-duty vehicles, such as tractor-trailers, and in particular to primary frames or movable subframes for heavy-duty vehicles. More specifically, the invention is directed to a shroud for a heavy-duty vehicle component, such as a valve of a pin release/locking system of a moveable subframe, a pneumatic valve for a heavy-duty system, an electronic transmission/communication device, a load scale, a bypass valve for automatic air spring dump, a height control valve, and the like. The shroud is attachable to a hanger and/or a main member of the primary frame or moveable subframe of the heavy-duty vehicle and enables mounting of the heavy-duty vehicle component within an interior space of the shroud. The shroud includes structure that substantially encloses the heavy-duty vehicle component when attached to the primary frame or moveable subframe, thereby protecting the component and/or associated structure from damage from road hazards potentially encountered during operation of the heavy-duty vehicle. The shroud includes structure that also provides clearance for heavy-duty vehicle axle/suspension system applications that utilize suspension assemblies having a forward mounted down-stop and provides a safety barrier between an operator and components of the forward mounted down-stop and the heavy-duty vehicle component and/or primary frame or moveable subframe during operation or use of the component, such as during manual operation of a valve of a pin release/locking system for a moveable subframe. In addition, the shroud includes structure that enables it to be temporarily mounted to a base member or cross-member of a heavy-duty vehicle moveable subframe, thereby providing the moveable subframe with desirable shipping density, that is, compactness of the shipped subframe, during shipping with the heavy-duty vehicle component and any associated structure attached, thereby decreasing shipping cost, as well as decreasing assembly time of the moveable subframe after shipping and reducing vehicle downtime.

### Background Art

Movable subframes, typically referred to as slider boxes, slider subframes, slider undercarriages, or slider secondary frames, have been utilized on heavy-duty vehicles, such as tractor-trailers or semi-trailers, for many years. One or more axle/suspension systems typically are suspended from a single slider box. Reference herein shall be made to a slider box by way of example, with the understanding that such reference applies to other types of moveable subframes and/or slider boxes outfitted with one, two, or more axle/suspension systems. The slider box in turn is mounted on the underside of the heavy-duty vehicle primary frame along the primary frame main members, and is movable/slidable longitudinally therealong to provide a means for variable load distribution and vehicle maneuverability, as is known in the art. For purposes of this disclosure, when reference is made to the term “heavy-duty vehicle frame”, it is to be understood that the term includes moveable subframes or primary frames for heavy-duty vehicles.

More specifically, the amount of cargo that a heavy-duty vehicle may carry is governed by local, state and/or national road and bridge laws, and is dependent on proper load distribution. The basic principle behind most road and bridge laws is to limit the maximum load that a heavy-duty vehicle may carry, as well as limit the maximum load that can be supported by individual axles. A heavy-duty vehicle having a slider box gains an advantage with respect to laws governing maximum axle loads. More particularly, proper placement of the slider box varies individual axle loads or redistributes the heavy-duty vehicle load so that it is within legal limits.

Once desirably positioned, the slider box is locked in place on the underside of the heavy-duty vehicle by one or more retractable pin mechanisms of a pin release/locking system. The pin release/locking system generally includes one or more retractable pin mechanisms with two or more, and typically four, slider pin assemblies with respective pins, which may be interconnected by a manually operated crank or other retraction mechanism, such as pneumatic or hydraulic lines. When the pins are in their retracted inboardmost position, the moveable subframe is unlocked from the heavy-duty vehicle primary frame main members to enable selective longitudinal positioning of the moveable subframe relative to the primary frame main members. When the pins are in their extended outboardmost position, they each extend through respective openings formed in the main members of the slider box and respective aligned openings formed in the heavy-duty vehicle primary frame main members, and thereby lock the slider box at the selected longitudinal position relative to the primary frame. Such retractable pin mechanisms are typically mechanically or pneumatically actuated, as is known in the art.

In pneumatically actuated retractable pin mechanisms of pneumatic pin release/locking systems, a plurality of pneumatic lines are typically operatively connected between a source of compressed air mounted on the heavy-duty vehicle, a manually operated pneumatic push/pull valve, and the slider pin assemblies of the pneumatically actuated retractable pin mechanisms. Manual operation of the push/pull valve by pulling a knob operatively connected to the valve causes retraction of the pins of the slider pin assemblies in a manner known in the art, which in turn unlocks the slider box from the main members of the heavy-duty vehicle primary frame, thereby enabling adjustment of the slider box position relative to the primary frame main members. Subsequent manual operation of the push/pull valve by pushing in the knob connected to the valve, or by other means, such as by releasing the parking brake, causes the pins to extend through the respective aligned openings formed in the main members of the slider box and the openings formed in the heavy-duty vehicle primary frame main members in a manner known in the art, to lock the slider box to the primary frame main members at the selected longitudinal position relative to the primary frame.

Because such manually operated pneumatic push/pull valves typically must be manually operated by a vehicle operator, the push/pull valve must be located at a position on the heavy-duty vehicle where an operator can access the valve to actuate unlocking and subsequent locking of the slider box, to allow the slider box to be positioned and locked at the selected longitudinal position relative to the heavy-duty vehicle primary frame. In addition, such push/pull valves must be located at a position on the heavy-duty vehicle in which the valves do not interfere with functionality of components of the axle/suspension system(s) attached to the slider box. Consequently, such push/pull valves typically are attached to the slider box adjacent the front of a hanger that connects the front-most axle/suspension system to the slider box in trailing arm axle/suspension systems, or adjacent the back of a hanger that connects the rear-most axle/suspension system in leading arm axle/suspension systems. Mounting of the push/pull valves at such locations also provides the pneumatic pin release/locking systems with efficient routing of the pneumatic lines utilized to operatively connect the source of compressed air mounted on the heavy-duty vehicle, the valves, and the slider pin assemblies.

Because such manually operated pneumatic push/pull valves are typically attached to the heavy-duty vehicle slider box adjacent a hanger, the valves are located beneath the vehicle in a relatively unprotected area and can potentially encounter hazards from the road during operation of the vehicle, such as road debris or other contaminants, which can potentially damage the valve and/or associated pneumatic lines of the pneumatic pin release/locking system connected to the valve. Accordingly, prior art mounting brackets have been utilized with such manually operated pneumatic push/pull valves to mount the valves to the slider box main members, and with some bracket designs, to provide some degree of protection to the push/pull valves during vehicle operation.

For example, in one such prior art mounting bracket, the mounting bracket is generally L-shaped and includes an integrally formed front wall and a side wall positioned approximately ninety degrees from one another. The front wall is formed with openings for attaching a manually operated push/pull valve via fasteners. The side wall of the mounting bracket is attached to a hanger of the slider box by any suitable means, such as welds, or is attached to other structure extending from the hanger, such as a second bracket, and extends frontwardly from the hanger or rearwardly from the hanger, depending on whether the slider box employs trailing arm or leading arm axle/suspension systems, respectively. The side wall is also formed with an opening to provide access to the knob of the push/pull valve to enable a vehicle operator to pull the knob to retract the pins of the slider pin assemblies of the pneumatic pin release/locking system and unlock the slider box from the primary frame main members of the heavy-duty vehicle to selectively position the slider box relative to the primary frame main members, and to push the knob to extend the pins to lock the slider box to the primary frame main members at the selected location, in the manner described above.

In another example of a prior art mounting bracket, the bracket is attached to a hanger or main member of the slider box by any suitable means, such as welds or fasteners. The bracket extends frontwardly from the hanger and functions merely to provide a structure for attaching the manually operated pneumatic push/pull valve and provides virtually no protection to the valve from hazards encountered from the road during vehicle operation.

While generally suitable for their intended purposes, such prior art mounting brackets have potential disadvantages, drawbacks, and limitations. For example, such prior art mounting brackets typically do not include structure that substantially encloses the push/pull valve during vehicle operation, which can potentially result in damage to the attached valves or attached pneumatic line connections of the pneumatic pin release/locking systems from road hazards potentially encountered during operation of the heavy-duty vehicle, such as road debris or other contaminants.

In addition, such prior art mounting brackets mount the manually operated pneumatic push/pull valves in a manner that provides inadequate clearance for an axle/suspension system suspension assembly employing a forward mounted down-stop. Forward mounted down-stops generally include a structure or extension attached to each suspension assembly of the axle/suspension system about a mounting tube attached to a beam of the suspension assembly, opposite the rearward extending beam, or “forward” of the beam in trailing arm axle/suspension systems. Upon downward pivotal movement of the axle/suspension system beams, the extension attached to each suspension assembly pivots upward until it contacts a structure, such as a bracket, mounted to and extending downwardly from the respective main member of the moveable subframe or primary frame of the heavy-duty vehicle, thereby inhibiting further downward movement of the beams, and thus an axle captured by and extending between the beams. Reference herein shall be made to “forward mounted down-stops” by way of example, with the understanding that such reference applies to down-stops with structure or extensions which limit downward movement of the axle/suspension system beams that are attached to or are “rearward” of the suspension assembly mounting tubes and opposite the forward extending beams in leading arm axle/suspension system configurations.

With manually operated pneumatic push/pull valves, the push/pull valves are mounted on the prior art mounting brackets in a manner, such that there is insufficient clearance for upward pivotal movement of the extensions of the forward mounted down-stops, which can result in damage to the valves and/or the associated pneumatic lines of the pneumatic pin release/locking system attached to the valves, rendering the mounting bracket virtually unusable with such forward mounted down-stops. In addition, even if such mounting brackets could be utilized with forward mounted down-stops, for example, by lengthening the brackets frontwardly to enable sufficient clearance for components of the forward mounted down-stops, because the mounting brackets do not substantially enclose the push/pull valves, the mounting brackets would not provide a safety barrier between an operator and components of the forward mounted down-stop and the valve and/or hanger of the slider box, which are known pinch points, during operation of the valve.

Furthermore, if such prior art mounting brackets are lengthened frontwardly to enable sufficient clearance for components of a forward mounted down-stop, in certain slider box configurations, the mounting brackets would extend beyond the longitudinal length of the main members of the slider box, and thus result in undesirable shipping density of the slider box if left attached during shipping, which could result in increased shipping costs. Such prior art mounting brackets also do not include structure that enables the mounting brackets to be temporarily mounted to the slider box during shipping at a location/position on the slider box that provides desirable shipping density to the slider box with the manually operated push/pull valve and associated pneumatic lines of the pneumatic pin release/locking system attached. Accordingly, such prior art mounting brackets, manually operated pneumatic push/pull valves, and associated pneumatic lines of the pneumatic pin release/locking system must typically be shipped detached from the slider box, which requires the bracket, valve and associated pneumatic lines to be mounted/attached on-site after shipping, thereby increasing the assembly time required to prepare the heavy-duty vehicle for operation and increasing vehicle downtime.

Alternatively, polycarbonate or metal valve boxes that enable the push/pull valves to be mounted to and encased within the boxes have been utilized to mount the valve to the slider box. Such valve boxes are typically mounted on a relatively large bracket attached to and extending frontwardly from a hanger of the slider box. While such valve boxes provide complete enclosure of the push/pull valves, the boxes are relatively large and require mounting on the relatively large brackets to provide sufficient mounting support for the boxes, and thus undesirably increase the overall weight of the heavy-duty vehicle. Such valve mounting boxes are also relatively complex, expensive to manufacture and require specialized plumbing of the pneumatic lines of the pneumatic pin release/locking system to accommodate mounting of the push/pull valve within the boxes, thereby increasing the overall cost and installation time of the pneumatic pin release/locking system. Furthermore, during operation of the heavy-duty vehicle, such valve mounting boxes completely encase the push/pull valves to provide protection to the valves from road hazards encountered during operation of the heavy-duty vehicle. In order to operate the push/pull valve to position the slider box at the selected location relative to the heavy-duty vehicle primary frame, the operator must open the box to access the valve, and thus the valve cannot be operated while the box is closed. In addition, when mounted to the slider box via the relatively large bracket, the valve mounting boxes typically interfere with components of a forward mounted down-stop, and thus cannot be utilized with such systems. Moreover, such valve mounting boxes do not include structure which enable the boxes to be temporarily mounted to the slider box during shipping at a location/position on the slider box that provides desirable shipping density to the slider box with the manually operated push/pull valve and associated pneumatic lines of the pneumatic pin release/locking system mounted within the box. Thus, this structure and arrangement requires the box, push/pull valve and associated pneumatic lines to be mounted/attached on-site after shipping, thereby increasing the assembly time required to prepare the heavy-duty vehicle for operation and increasing vehicle downtime.

Thus, a need exists in the art for a shroud for a heavy-duty vehicle component that is attachable to a heavy-duty vehicle frame and enables mounting of the component within the shroud to substantially enclose and protect the component, and thus prevent damage to the component and/or associated structure from road hazards potentially encountered during operation of the vehicle. There is also a need in the art for a shroud for a heavy-duty vehicle component that includes structure that provides clearance for components of a suspension assembly forward mounted down-stop and provides a safety barrier between an operator and components of the forward mounted down-stop and the component and/or heavy-duty vehicle frame during operation or use of the component. In addition, there is a need in the art for a shroud for a heavy-duty vehicle component that includes structure enabling it to be to be temporarily mounted to a moveable subframe in a position/location, such as a base member or cross-member, that provides desirable shipping density to the moveable subframe during shipping with the component and associated structure attached, thereby decreasing shipping cost, as well as decreasing assembly time of the moveable subframe after shipping and reducing vehicle downtime. The shroud for a heavy-duty vehicle component of the disclosed subject matter satisfies these needs and will be described below.

### SUMMARY OF THE INVENTION

An objective of the disclosed subject matter includes providing a shroud for a heavy-duty vehicle component that enables mounting of the component, and that substantially encloses and protects the component when the shroud is attached to the heavy-duty vehicle frame.

A further objective of the disclosed subject matter is to provide a shroud for a heavy-duty vehicle component that provides clearance for components of an axle/suspension system suspension assembly employing a forward mounted down-stop.

Yet another objective of the disclosed subject matter is to provide a shroud for a heavy-duty vehicle component that provides a safety barrier between an operator and components of a forward mounted down-stop and the component and/or heavy-duty vehicle frame.

Still another objective of the disclosed subject matter is to provide a shroud for a heavy-duty vehicle component that can be temporarily mounted to a heavy-duty vehicle moveable subframe in a position/location that provides desirable shipping density to the moveable subframe during shipping with the component and associated structure attached.

These objectives and others are achieved by the shroud for a heavy-duty vehicle component, which comprises a front wall and a pair of side walls spaced apart from and rigidly connected to the front wall, the side walls and the front wall forming a hollow interior space within the shroud, the shroud being removably attached to a heavy-duty vehicle frame at a selected location; and the component being mounted on at least one of the front wall and the side walls within the interior space, the shroud substantially enclosing the component when the shroud is mounted at the selected location on the heavy-duty vehicle frame.

### BRIEF DESCRIPTION OF THE SEVERAL VIEWS OF THE DRAWINGS

An exemplary embodiment of the disclosed subject matter, illustrative of the best mode in which Applicant has contemplated applying the principles, is set forth in the following description, is shown in the drawings, and is particularly and distinctly pointed out and set forth in the appended claims.

FIG. 1 is a driver side perspective view of a slider box for a heavy-duty vehicle having a pneumatic pin release/locking system, showing a manually operated pneumatic push/pull valve of the pneumatic pin release/locking system attached to the slider box with a prior art mounting bracket;

FIG. 2 is an enlarged exploded view of the prior art mounting bracket and manually operated pneumatic push/pull valve shown in FIG. 1;

FIG. 3 is a fragmentary driver side elevational view of a slider box for a heavy-duty vehicle with a trailing arm axle/suspension system that incorporates a forward mounted down-stop, with hidden components shown in phantom lines, showing a shroud for a manually operated valve of a pin release/locking system of a heavy-duty vehicle moveable subframe of the disclosed subject matter attached to a hanger and main member of the slider box, and with a manually operated pneumatic push/pull valve of the pin release/locking system attached thereto;

FIG. 4 is a driver side perspective view of the shroud for a manually operated valve of a pin release/locking system of a heavy-duty vehicle moveable subframe of the disclosed subject matter and attached manually operated pneumatic push/pull valve of FIG. 3, shown removed from the slider box;

FIG. 5 is a passenger side perspective view of the shroud for a manually operated valve of a pin release/locking system of a heavy-duty vehicle moveable subframe of the disclosed subject matter and attached manually operated pneumatic push/pull valve of FIG. 3, shown removed from the slider box;

FIG. 6 is a rear elevational view of the shroud for a manually operated valve of a pin release/locking system of a heavy-duty vehicle moveable subframe of the disclosed subject matter and attached manually operated pneumatic push/pull valve of FIG. 3, shown removed from the slider box; and

FIG. 7 is a bottom fragmentary perspective view of the slider box for a heavy-duty vehicle of FIG. 3, showing the shroud for a manually operated valve of a pin release/locking system of a heavy-duty vehicle moveable subframe of the disclosed subject matter and attached manually operated pneumatic push/pull valve, mounted to a bottom surface of a base member of the slider box prior to shipping of the slider box.

Similar numerals refer to similar parts throughout the drawings.

### DESCRIPTION OF THE EXEMPLARY EMBODIMENT

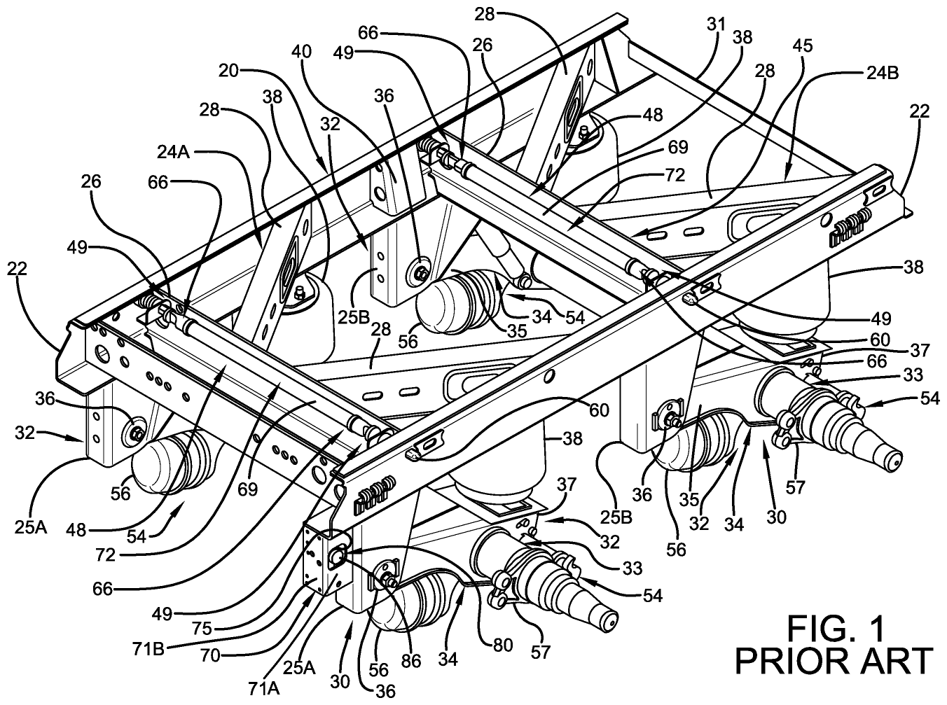

In order to better understand the environment in which the shroud for a heavy-duty vehicle component of the disclosed subject matter is utilized, a heavy-duty vehicle slider box 20 is shown in FIG. 1 and will be described below.

Slider box 20 is of the type shown and described in U.S. Pat. No. 5,720,489, which is assigned to Applicant of the instant application, Hendrickson USA, L.L.C. Slider box 20 generally includes a pair of elongated, longitudinally extending and spaced-apart parallel main members 22. Main members 22 are connected to each other by a pair of K-shaped cross members 24A and 24B. K-shaped cross members 24A,24B extend between, typically nest in, and are welded to main members 22 to form slider box 20. More specifically, each main member 22 is a generally C-shaped or G-shaped cross-sectional beam typically made from a suitable rigid material, such as steel or composite. The open portion of each main member 22 is opposed to the open portion of the other main member and faces inboardly relative to slider box 20. Each K-shaped cross member 24A,24B is formed of a suitable rigid material, such as steel or composite, and includes a base member 26, which extends between, and is perpendicular to, main members 22, and two inclined or angled cross brace members 28, each of which extend in a generally diagonal manner between a generally central portion of the base member and a respective one of the main members. Each end of base member 26 and the outboard end of each cross brace member 28 nests in the open portion of a respective one of main members 22, and are secured therein by any suitable means, such as welds, creating generally concentrated loadings at the point of attachment, as is known. A reinforcement bar 31 is mounted on and extends between the rear ends of main members 22 to provide additional strength to the overall structure of slider box 20. Slider box 20 includes a pair of front and rear hangers 25A and 25B, respectively, which are attached to the bottom of main members 22 and are utilized for suspending tandem trailing arm axle/suspension systems 30, the structure and function of which is generally well known in the art. A pair of steel reinforcement boxes 40 (only one shown) are mounted on main members 22 adjacent to and above rear hangers 25B to provide additional strength to slider box 20 for supporting the hangers and pivotally attached axle/suspension systems 30.

Each axle/suspension system 30 includes a pair of generally identical suspension assemblies 32, each suspended from a respective one of pair of front hangers 25A or rear hangers 25B of slider box 20. Because suspension assemblies 32 are generally the same or mirror images of one another, for the purpose of conciseness, only a single suspension assembly will be described. Suspension assembly 32 includes a beam 34 that is pivotally mounted to front or rear hanger 25A, 25B via a bushing assembly 36 disposed within a mounting tube (not shown) attached to a front end 35 of the beam. An air spring 38 is suitably mounted on and extends between the upper surface of a rear end 37 of beam 34 and main member 22. An axle 33 extends between and is captured by and extends between beams 34. One or more wheels (not shown) are mounted on each end of axle 33 in a known manner. For completeness, suspension assembly 32 is shown with components of a drum brake system 54, including a brake air chamber 56 and a brake spider 57, the structure and function of which is well known in the art.

Slider box 20 employs a pneumatic pin release/locking system 45 to lock/unlock slider box 20 to/from the main members (not shown) of a primary frame (not shown) of a heavy-duty vehicle. More specifically, pneumatic pin release/locking system 45 includes a pair of pneumatic retractable pin mechanisms 48. Each retractable pin mechanism 48 includes a pair of slider pin assemblies 49 attached to each end of a retraction mechanism 72. Because slider pin assemblies 49 are generally identical to one another, for the purpose of conciseness, only one of the slider pin assemblies will be described with the understanding that a generally identical slider pin assembly is attached to the opposite side of the retraction mechanism. Retraction mechanism 72 includes an inflatable bladder 69 connected at each one of its ends to an end cap 66, which is in turn connected to slider pin assembly 49. As retraction mechanism 72 is activated by inflation via an air source, end caps 66 are pulled inboardly, thus moving a pin 60 of slider pin assembly 49 out of engagement with an opening (not shown) formed in the main member (not shown) of the heavy-duty vehicle primary frame and an aligned opening (not shown) formed in main member 22 of slider box 20, which in turn enables movement of the slider box along the main members of the primary frame for selective repositioning of the slider box relative to the primary frame. When retraction mechanism 72 is de-activated via deflation, end caps 66 are pushed outboardly, thus moving pin 60 of slider pin assembly 49 into engagement with the opening (not shown) of main member 22 of slider box 20 and an aligned opening (not shown) formed in the main member of the heavy-duty vehicle primary frame to lock the slider box in the selected position relative to the frame.

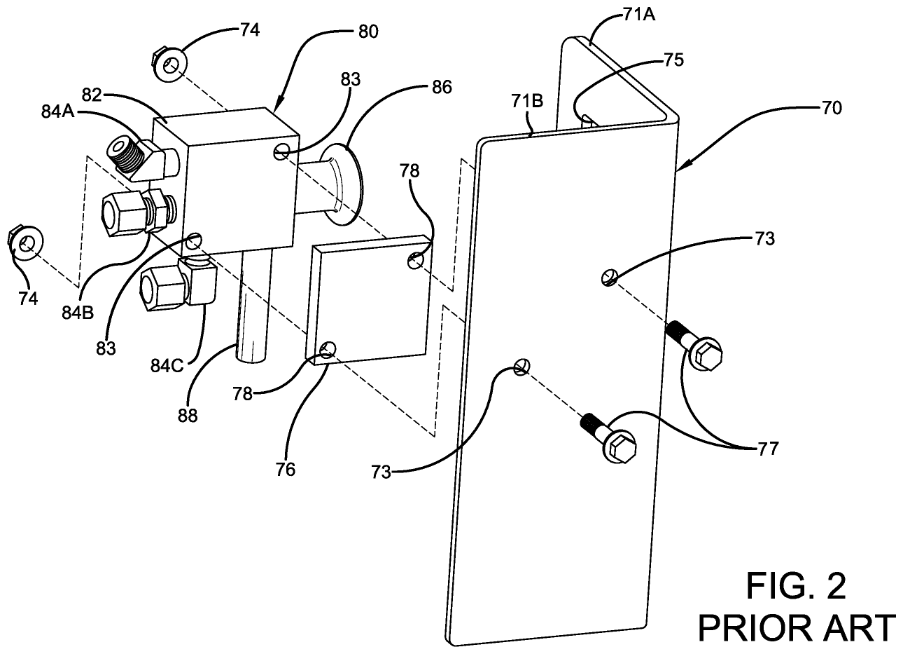

With reference to FIGS. 1-2, pneumatic pin release/locking system 45 includes a manually operated pneumatic push/pull valve 80. Push/pull valve 80 is of the type shown and described in WIPO Publication No. WO 00/56592 of PCT Application No. PCT/US00/00341, which is assigned to The Boler Company. Push/pull valve 80 includes a structure that enables activation and de-activation of retraction mechanisms 72 of retractable pin mechanisms 48. More specifically, and with particular reference to FIG. 2, push/pull valve 80 includes a valve body 82. Valve body 82 is formed with a pair of longitudinally extending openings 83, the importance which will be described below. A plurality of fittings 84A,84B,84C threadably engage corresponding openings (not shown) formed in valve body 82, and enable connection of an actuation line (not shown), an emergency air supply line (not shown), and an air reservoir line (not shown), respectively, of pneumatic pin release/locking system 45. An exhaust tube 88 is also connected to valve body 82 via an exhaust opening (not shown) formed in the valve body.

Valve body 82 of manually operated pneumatic push/pull valve 80 further includes a knob 86 operably connected to the valve body. Knob 86 enables a vehicle operator to manually operate push/pull valve 80. When knob 86 is pulled by the vehicle operator, retraction mechanism 72 is activated/inflated, which causes retraction of pins 60 out of the respective openings formed in the heavy-duty vehicle primary frame main members and main members 22 of slider box 20. This in turn unlocks slider box 20 from the primary frame main members, enabling adjustment of the slider box position relative to the primary frame main members. Once slider box 20 is positioned at the desired selected location relative to the main members of the heavy-duty vehicle primary frame, subsequent manual operation of the push/pull valve 80 by pushing knob 86 back in results in de-activation/deflation of retraction mechanism 72, which in turn causes extension of pins 60 into respective aligned openings formed in main members 22 of slider box 20 and the primary frame main members. This in turn locks slider box 20 to the heavy-duty vehicle primary frame main members at the desired selected position.

With continued reference to FIGS. 1-2, manually operated pneumatic push/pull valve 80 is mounted on slider box 20 with a prior art mounting bracket 70. Prior art mounting bracket 70 is generally L-shaped and is formed of a rigid material, such as steel. More specifically, prior art mounting bracket 70 includes a side wall 71A integrally formed and generally perpendicular to a front wall 71B, such that the side wall is positioned approximately ninety-degrees from the front wall. Prior art mounting bracket 70 is attached to the driver-side main member 22 of slider box 20 by means known in the art, such as welding or attachment to a bracket (not shown) extending frontwardly from the driver-side front hanger 25A.

Front wall 71B is formed with a pair of bolt openings 73, which enable mounting of manually operated pneumatic push/pull valve 80. More specifically, a spacer 76 is positioned between front wall 71B of prior art mounting bracket 70 and valve body 82. Spacer 76 is formed with a pair of longitudinally extending openings 78. Bolt openings 73 of front wall 71B align longitudinally with openings 78 of spacer 76 and openings 83 formed in valve body 82 of push/pull valve 80. A pair of bolts 77 are disposed through respective aligned ones of bolt openings 73 of front wall 71B, openings 78 of spacer 76, and openings 83 of valve body 82, and are utilized to secure push/pull valve 80 and spacer 76 to front wall 71B of prior art mounting bracket 70 via nuts 74. Side wall 71A is formed with a knob opening 75 (FIGS. 1-2). Opening 75 is transversely aligned with knob 86 of push/pull valve 80, and is sized to enable a vehicle operator to access the knob to manually operate the valve in the manner described above.

While generally suitable for its intended purpose, prior art mounting bracket 70 has various potential disadvantages, drawbacks, and limitations. For example, prior art mounting bracket 70 does not include structure that provides substantial enclosure of manually operated pneumatic push/pull valve 80 when attached to slider box 20, which can potentially result in damage to the valve or associated components of pneumatic pin release/locking system 45 from road hazards potentially encountered during operation of the heavy-duty vehicle, such as road debris or other contaminants. More specifically, because prior art mounting bracket 70 is attached to the front of front hanger 25A adjacent the bottom of main member 22 of slider box 20, and side wall 71A and front wall 71B are positioned only in the front and on the outboard or driver-side of push/pull valve 80, the bottom and inboard side of the valve are virtually unprotected from road hazards potentially encountered during operation of the heavy-duty vehicle, which can potentially result in damage to the valve or associated components of pneumatic pin release/locking system 45 connected to the valve via fittings 84A,84B,84C.

Furthermore, prior art mounting bracket 70 mounts manually operated pneumatic push/pull valve 80 at a position on the mounting bracket that provides inadequate clearance for components of a forward mounted down-stop, such as during upward pivotal movement of a front extension of the forward mounted down-stop, in axle/suspension systems that employ such down-stops, rendering the prior art mounting bracket unusable with suspension assemblies that employ such forward mounted down-stops. Also, even if prior art mounting bracket 70 could be utilized with such forward mounted down-stops, because the bottom and inboard side of push/pull valve 80 is exposed and unprotected by the prior art mounting bracket, the prior art mounting bracket would not provide a safety barrier between an operator and components of the forward mounted down-stop and the valve and/or hanger 25A of slider box 20, which are known pinch points, during operation of the valve.

In addition, if prior art mounting bracket 70 where to be lengthened frontwardly to enable sufficient clearance for a forward mounted down-stop, for example by lengthening side wall 71A frontwardly so that attached manually operated pneumatic push/pull valve 80 does not interfere with components of a forward mounted down-stop, the mounting bracket would extend beyond the longitudinal length of the main members of the slider box in certain slider box configurations, and thus result in undesirable shipping density of the slider box if left attached during shipping, which could result in increased shipping costs. Moreover, if prior art mounting bracket 70 extends frontwardly beyond the longitudinal length of a main member of a slider box to enable sufficient clearance for a forward mounted down-stop, in certain slider box configurations, the bracket and attached push/pull valve 80 would be the frontwardmost structures extending from the slider box. Consequently, if left attached during shipping, prior art mounting bracket 70, push/pull valve 80, and/or the associated pneumatic lines of pneumatic pin release/locking system 45 could potentially become damaged and/or detached from the slider box and/or one another during shipping, such as by striking objects in the shipping environment during loading/unloading of the slider box onto/from the shipping means or by being struck by a tow motor.

Prior art mounting bracket 70 does not include structure that enables it to be temporarily mounted to slider box 20 at a position on the slider box that provides desirable shipping density to the slider box with manually operated pneumatic push/pull valve 80 and associated pneumatic lines of pneumatic pin release/locking system 45 attached, which requires the mounting bracket, valve, and associated pneumatic lines to be shipped detached from the slider box and mounted/attached on-site, thereby increasing the assembly time required to prepare the heavy-duty vehicle for operation and increasing vehicle downtime. The shroud for a heavy-duty vehicle component of the disclosed subject matter overcomes the potential disadvantages, drawbacks, and limitations associated with prior art mounting bracket 70 and will now be described.

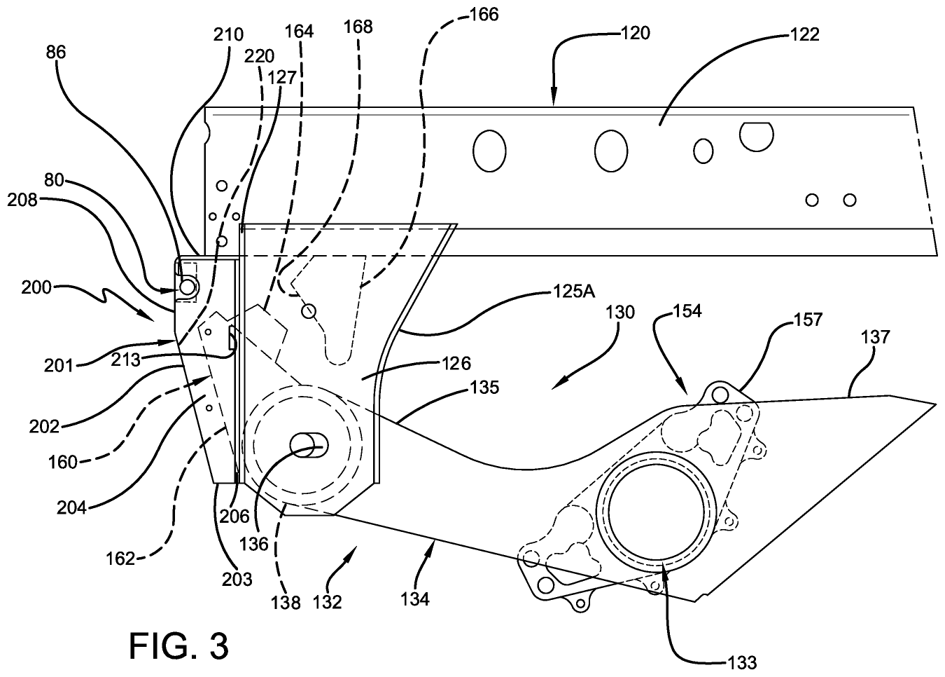

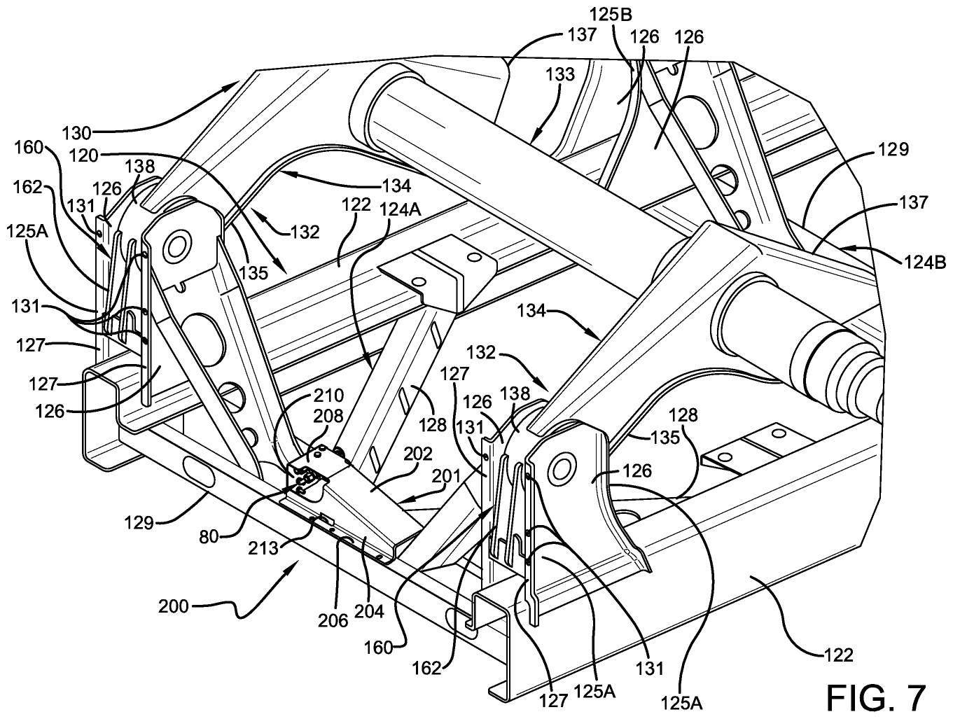

An exemplary embodiment shroud for a heavy-duty vehicle component of the disclosed subject matter, and in particular, for a manually operated valve of a pin release/locking system of a heavy-duty vehicle moveable subframe is shown in FIGS. 3-7 and is indicated generally at 200. Exemplary embodiment shroud 200 is shown utilized in conjunction with a slider box 120. Slider box 120 is of the type shown and described in U.S. Pat. No. 8,496,259, which is assigned to Applicant of the instant application, Hendrickson USA, L.L.C. Slider box 120 includes a pair of elongated, longitudinally extending and spaced-apart parallel main members 122 from which one or more trailing arm axle/suspension systems 130 (only one shown) depend. With reference to FIG. 7, main members 122 are connected to each other by a pair of K-shaped cross members 124A and 124B. More specifically, each main member 122 is a generally C-shaped or G-shaped cross-sectional beam typically made from a suitable rigid material, such as steel or composite. The open portion of each main member 122 is opposed to the open portion of the other main member and faces inboardly relative to slider box 120. K-shaped cross members 124A,124B extend between, typically nest in, and are welded to main members 122 to form slider box 120. Each K-shaped cross member 124A,124B includes a base member 129, which extends between and is perpendicular to main members 122 and nests within the main members rearwardly of the front ends of main members. Each K-shaped cross member 124A,124B also includes two inclined or angled cross brace members 128, each of which extend in a generally diagonal manner between a generally central portion of base member 129 and a respective one of the main members 122. Each end of base member 129 and the outboard end of each cross brace member 128 nests in an open portion of a respective one of main members 122, and are secured therein by any suitable means, such as welds. Slider box 120 includes a pair of front hangers 125A and rear hangers 125B (only one shown), which are attached to the bottom of main members 122 and are utilized for suspending axle/suspension systems 130. More specifically, and with particular reference to FIG. 7, front hangers 125A and rear hangers 125B each include a pair of transversely spaced-apart side walls 126, which extend longitudinally parallel to one another, with each being located on a respective inboard side and outboard side of the respective main member 122, and are utilized to attach the front hangers and the rear hangers to the main members via suitable means, such as welds, and to pivotally attach axle/suspension systems 130. Each one of side walls 126 of front hanger 125A includes a flange 127 formed at the front end of the side wall along the side wall vertical length, the importance of which will be described in detail below. Flange 127 of the inboard side wall 126 extends inboardly perpendicular from the inboard side wall, and the flange of the outboard side wall extends outboardly perpendicular from the outboard side wall.

Axle/suspension systems 130 are generally similar in structure and function to axle/suspension systems 30 described above, except that they utilize one or more forward mounted down-stops 160 (FIGS. 3 and 7). With reference to FIGS. 3 and 7, each axle/suspension system 130 includes a pair of generally identical suspension assemblies 132, each suspended from a respective one of pair of front hangers 125A or rear hangers 125B (FIG. 7) attached to main members 122 of slider box 120. Because suspension assemblies 132 are generally the same or mirror images of one another, for the purpose of conciseness, only a single suspension assembly will be described. With reference to FIG. 3, suspension assembly 132 includes a beam 134 that is pivotally mounted at a front end 135 to the driver-side front hanger 125A via a bushing assembly 136 disposed within a mounting tube 138 attached to the front end of the beam, such that the beam is positioned between side walls 126 of the front hanger. An air spring (not shown) is suitably mounted on and extends between the upper surface of a rear end 137 of beam 134 and main member 122. An axle 133 extends between and is captured by beams 134. One or more wheels (not shown) are mounted on each end of axle 133 in a known manner. For completeness, suspension assembly 132 is shown with a torque plate 157 (FIG. 3) of an air disc brake system 154 attached to axle 133.

With continued reference to FIGS. 3 and 7, axle/suspension system 130 further includes one or more forward mounted down-stops 160. Forward mounted down-stop 160 is of the type shown and described in U.S. Patent Application Publication No. 2019/0054787 of U.S. patent application Ser. No. 16/056,645, which is assigned to Applicant of the instant application, Hendrickson USA, L.L.C. Forward mounted down-stop 160 includes an extension 162 that is attached to the front of mounting tube 138 of suspension assembly 132, and thus is attached to the mounting tube opposite front end 135 of beam 134. With reference to FIG. 3, forward mounted down-stop 160 also includes a bumper 164 formed of a rigid and durable material, such as a synthetic polymer, elastomer, or composite, which is mounted on extension 162 and extends generally upwardly from the extension. Forward mounted down-stop 160 also includes an engagement member 166, which is fixed to and suspends from the driver-side main member 122 of slider box 120. Engagement member 166 includes a surface 168 for contacting bumper 164 to limit downward pivotal movement of beam 134, and thus axle 133, about the pivotal connection of the beam to front hanger 125A, as is known.

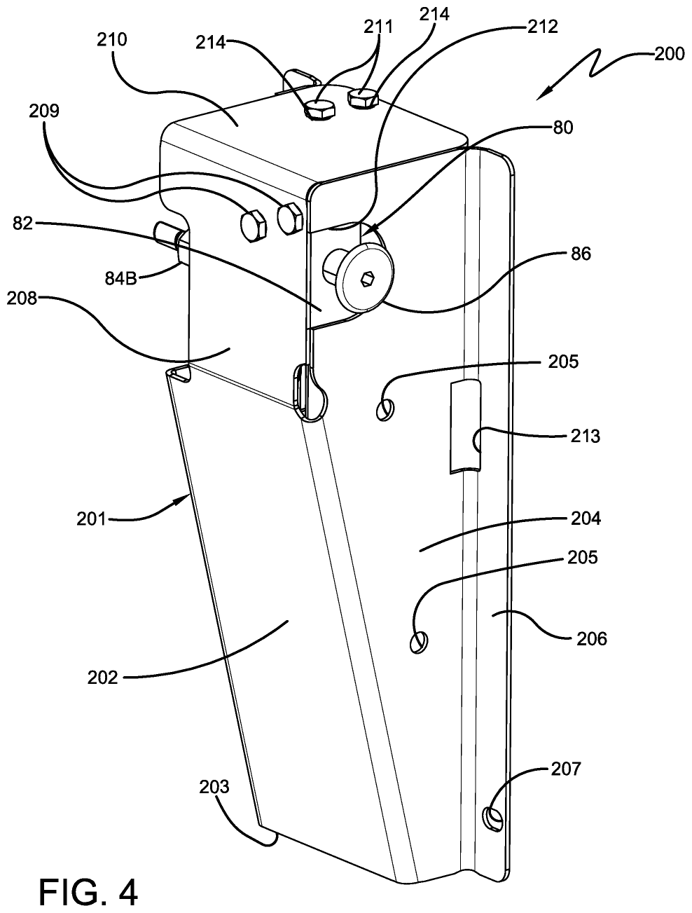

With reference to FIGS. 3-6, exemplary embodiment shroud for a manually operated valve of a pin release/locking system of a heavy-duty vehicle moveable subframe 200 includes a one-piece, generally wedge-shaped hollow structure formed of a suitable sturdy material, such as metal, composites, or polymers formed via stamping, laser cutting, molding, or other suitable methods. Exemplary embodiment shroud 200 preferably is formed by stamping sheet metal, such as sheet steel. Shroud 200 includes a pair of side walls 204 integrally formed with and transversely spaced apart from one another by a front wall 201. More specifically, front wall 201 includes a top portion 208 and a bottom portion 202. Bottom portion 202 extends angularly rearwardly downwardly from top portion 208 and is integrally formed with side walls 204, such that the side walls taper moving from the top to the bottom of the side walls to give shroud 200 a downward/rearward taper relative to main members 122 of slider box 120, and provides the general wedge-shape to the shroud, with only a relatively narrow opening 203 (FIGS. 3-6) formed at the bottom of the shroud. Top portion 208 of front wall 201 extends upwardly from bottom portion 202 along the upper portion of side walls 204 generally perpendicular to main members 122. Top portion 208 is rigidly attached to the upper portion of side walls 204 by any suitable means, such as welding or fasteners (not shown), such as bolts. Top portion 208 is formed with a pair of openings (not shown) for mounting manually operated pneumatic push/pull valve 80, which will described in detail below. A top wall 210 is integrally formed with and extends rearwardly perpendicular to top portion 208 of front wall 201 along the top edges of side walls 204, and is rigidly attached to the top edges of the side walls by any suitable means, such as welding or fasteners (not shown), such as bolts. With particular reference to FIG. 4, the driver-side side wall 204 of shroud 200 is formed with a pair of vertically aligned openings 205, which enable mounting of an accessory bracket (not shown) for mounting various accessories, such as valves (not shown) or scales (not shown), for use with pneumatic pin release/locking system 45, slider box 120, and/or axle/suspension systems 130.

A flange 206 is integrally formed with each side wall 204 along the vertical length of the rear end of the respective side wall. Flange 206 that is integrally formed with the inboard side wall 204 extends inboardly perpendicular to the inboard side wall, and the flange integrally formed with the outboard side wall extends outboardly perpendicular to the outboard side wall. Although exemplary embodiment shroud 200 is shown and described as having a single-piece construction with front wall 201, side walls 204, top wall 210, and flanges 206 integrally formed with one another, it is to be understood that the shroud could include a construction in which two or more of the front wall, side walls, top wall, and/or flanges are discrete components that are welded or otherwise rigidly attached to the other components or each other, without affecting the overall concept or operation of the disclosed subject matter.

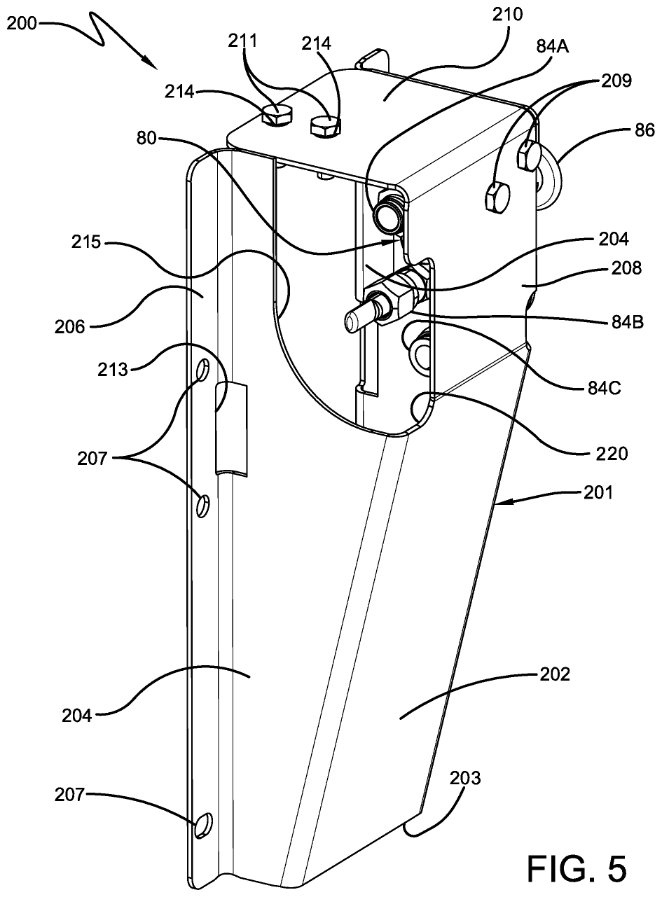

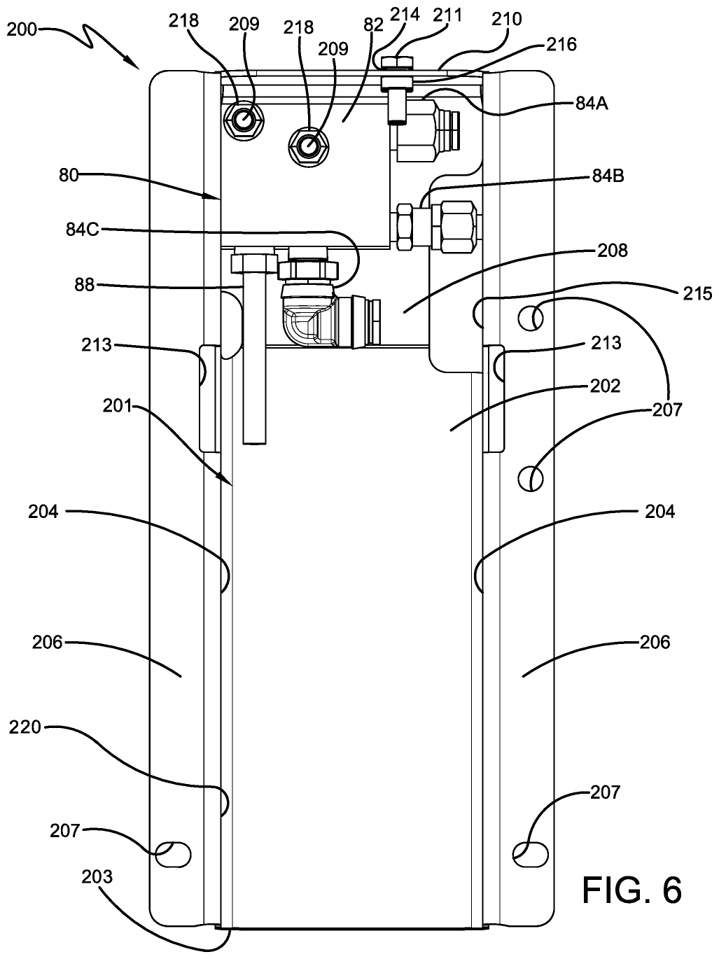

Flanges 206 are formed with a plurality of openings 207. Openings 207 enable exemplary embodiment shroud 200 for a manually operated valve of a pin release/locking system of a heavy-duty vehicle subframe of the disclosed subject matter to be mounted to front hanger 125A. More specifically, flanges 206 are positioned against flanges 127 of sidewalls 126 of front hanger 125A, such that openings 207 align with corresponding openings 131 formed in the front hanger flanges. A plurality of fasteners (not shown), such as bolts, are disposed through aligned ones of openings 207 and the corresponding openings 131 formed in flanges 127 of side walls 126 and are utilized to secure shroud 200 to the hanger via nuts (not shown), such that top wall 210 of the shroud is adjacent to or abuts the bottom of the driver side main member 122 of slider box 120. Top wall 210 of shroud 200 is formed with a pair of openings 214 (FIGS. 4-5), which align vertically with a pair of corresponding openings (not shown) formed in the bottom of the driver-side main member 122. Bolts 211 (FIGS. 4-6) are disposed through aligned ones of openings 214 and the corresponding openings formed in the bottom of the driver side main member 122 of slider box 120 and are utilized to secure top wall 210, and thus shroud 200, to the main member 122 via nuts 216 (FIG. 6). In this manner, shroud 200 is removably secured to slider box 120. It is to be understood that in certain circumstances exemplary embodiment shroud 200 could be attached to only one of the bottom of main member 122 or flanges 127 of side walls 126 of front hanger 125A without affecting the overall concept or operation of the disclosed subject matter.

Top portion 208 of front wall 201 is formed with a pair of openings (not shown) that enable manually operated pneumatic push/pull valve 80 of pneumatic pin release/locking system 45 to be connected to exemplary embodiment shroud 200. More specifically, openings 83 of valve body 82 of push/pull valve 80 are formed in the body such that they align with the pair of openings formed in top portion 208 of front wall 201. A pair of mounting bolts 209 (FIGS. 4-6) are disposed through respective ones of aligned openings 83 of valve body 82 and the openings formed in top portion 208 of front wall 201 and secure push/pull valve 80 to the top portion of the front wall, and thus to shroud 200, via nuts 218.

With reference to FIGS. 3-4, the outboard side wall 204 of exemplary embodiment shroud for a manually operated valve of a pin release/locking system of a heavy-duty vehicle moveable subframe 200 is formed with a knob access cutout or an opening 212, which enables a vehicle operator to operate manually operated pneumatic push/pull valve 80 in the manner described in the description above, to unlock/lock slider box 120 from the heavy-duty vehicle primary frame main members to selectively position the slider box longitudinally relative to the vehicle primary frame. Knob access opening 212 is preferably sized such that it is only as large as is required to enable manual operation of push/pull valve 80. The inboard side wall 204 of shroud 200 is formed with a cutout or an opening 215 near the top of the side wall, which enables passage of pneumatic lines (not shown) of pneumatic pin release/locking system 45 connected to fittings 84A, 84B, and 84C of push/pull valve 80. Opening 215 is also preferably sized such that is only as large as is necessary to provide passage of and access to the pneumatic lines of pneumatic pin release/locking system 45 and the respective connections to push/pull valve 80 via fittings 84A, 84B, and 84C, as well as enable removal of and replacement of the valve.

In accordance with an important aspect of the disclosed subject matter, exemplary embodiment shroud for a manually operated valve of a pin release/locking system of a heavy-duty vehicle moveable subframe 200 enables mounting of manually operated pneumatic push/pull valve 80 within the shroud in a manner which substantially encloses the valve, and thus protects the valve from potential road hazards encountered during vehicle operation. More specifically, side walls 204, top portion 208 and bottom portions 202 of front wall 201, and top wall 210 of exemplary embodiment shroud 200 are integrally formed/connected such that the shroud includes a hollow wedge shaped interior space 220. Because shroud 200 enables mounting of push/pull valve 80 on top portion 208 of front wall 201 within interior space 220, and the shroud includes a generally wedged shaped structure with only a relatively narrow opening 203 (FIGS. 3-6) at the bottom of the shroud, and includes relatively small knob access opening 212 and opening 215 formed in side walls 204 near the top of the side walls, once the shroud is attached to flanges 127 of side walls 126 of front hanger 125A, the valve is substantially enclosed by side walls 204, top portion 208 and bottom portion 202 of front wall 201, and top wall 210 of the shroud. Shroud 200 is thus protected from road hazards potentially encountered during operation of the heavy-duty vehicle, while still providing access for a vehicle operator to manually operate push/pull valve 80 via knob 86. It is to be understood that exemplary embodiment shroud 200 could be formed without top wall 210 and utilize the bottom of main member 122 of slider box 120 in conjunction with side walls 204, and top portion 208 and bottom portion 202 of front wall 201, to substantially enclose and protect push/pull valve 80 when attached to the slider box, without affecting the overall concept or operation of the disclosed subject matter.

In accordance with another important aspect of the disclosed subject matter, the structure of exemplary embodiment shroud for a manually operated valve of a pin release/locking system of a heavy-duty vehicle moveable subframe 200 enables it to be utilized with axle/suspension systems that employ forward mounted down-stops, such as forward mounted-down-stop 160 described above. More specifically, because shroud 200 enables manually operated pneumatic push/pull valve 80 to be mounted to top portion 208 of front wall 201 in the manner described above, the valve is located adjacent the top of the shroud within interior space 220, and at a position within the interior space that provides sufficient clearance for upward and downward pivotal movement of extension 162 or other components of forward mounted down-stop 160 within the interior space. It is to be understood that push/pull valve 80 could be mounted to shroud 200 within interior space 220 at other locations without affecting the overall concept or operation of the disclosed subject matter. For example, push/pull valve 80 could be attached to one of side walls 204 within interior space 220 adjacent the top of shroud 200 via threaded engagement of fasteners disposed through respective openings formed in the side wall and aligned threaded openings formed in the valve, while still providing clearance for extension 162 or other components of forward mounted down-stop 160. Thus, exemplary embodiment shroud 200 of the disclosed subject matter provides sufficient clearance for a forward mounted down-stop, such as forward mounted down-stop 160, and can be utilized with slider boxes with axle/suspension systems that employ such down-stops, such as slider box 120 with axle/suspension systems 130.

In accordance with yet another important aspect of the disclosed subject matter, exemplary embodiment shroud for a manually operated valve of a pin release/locking system of a heavy-duty vehicle moveable subframe 200 provides a safety barrier between an operator and components of forward mounted down-stop 160 and manually operated pneumatic push/pull valve 80 and/or slider box 120. More specifically, because forward mounted down-stop 160 relies on contact of bumper 164 with surface 168 of engagement member 166 via upward pivotal movement of extension 162 during downward pivotal movement of beam 134, and front hanger 125A is open between inboard and outboard side walls 126, a pinch point exists between flanges 127 of side walls 126 of front hanger 125A and extension 162 and between push/pull valve 80 and the extension. Because side walls 204, top portion 208 and bottom portion 202 of front wall 201, and top wall 210 of shroud 200 are integrally formed/connected to one another, and the shroud is attached to or otherwise contacts flanges 127 of side walls 126 of front hanger 125A along the length of flanges 206, extension 162 of forward mounted down-stop 160 is effectively enclosed within the shroud and the hanger inboard and outboard side walls. Shroud 200 thus isolates access to components of forward mounted down-stop 160, such as extension 162. This effectively creates a safety barrier between a vehicle operator and extension 162 of forward mounted down-stop 160 and flanges 127 of side walls 126 of front hanger 125A and/or between the extension and push/pull valve 80. Thus, exemplary embodiment shroud 200 of the disclosed subject matter provides a safety barrier between an operator and components of forward mounted down-stop 160 and side walls 126 of front hanger 125A and/or push/pull valve 80, which are known pinch points, during operation of the valve.

In accordance with still yet another important aspect of the disclosed subject matter, exemplary embodiment shroud for a manually operated valve of a pin release/locking system of a heavy-duty vehicle moveable subframe 200 includes structure that enables the shroud to be temporarily attached to slider box 120 during shipping in a manner that provides the slider box with desirable shipping density, while allowing manually operated pneumatic push/pull valve 80 with attached pneumatic lines (not shown) of pneumatic pin release/locking system 45 to be mounted to the shroud. More specifically, and with reference to FIG. 7, slider box 120 is typically positioned upside down during shipping. Flanges 206 of shroud 200 extend outwardly from side walls 204, such that they can be positioned on and contact the bottom surface of base member 129 of K-shaped cross member 124A of slider box 120, and thus enable the shroud to sit on the base member within the longitudinal width of the base member. Shroud 200 is positioned on base member 129 approximately at the transverse centerline of the base member between front hangers 125A. Openings 207 (FIGS. 4-6) of flanges 206 align with corresponding openings (not shown) formed in base member 129. A fastener (not shown) is disposed through each aligned opening 207 of flange 206 and corresponding opening of base member 129 and is utilized to removably secure exemplary embodiment shroud 200 to base member 129, and thus to slider box 120.

A pair of aligned cutouts 213 (FIGS. 3-7) are formed in and extend between respective side walls 204 and flanges 206 of shroud 200. During shipping of slider boxes 120, two or more of the slider boxes typically are stacked on top of each other in an upside down configuration as shown in FIG. 7, and secured to one another with metal banding to maximize the number of slider boxes that can be shipped at a time. Cutouts 213 enable the metal banding (not shown) to be disposed through the cutouts in order to enable two stacked slider boxes 120 with respective exemplary embodiment shrouds 200 removably connected to their respective base member 129, to be secured together, while preventing damage to the shrouds when tightening the banding to secure the slider boxes together.

With continued reference to FIG. 7, because base member 129 is positioned rearwardly of the front end of main members 122 of slider box 120, and because exemplary embodiment shroud 200 extends within the longitudinal width of the base member, the shroud is also positioned rearwardly of the front ends of the main members of the sider box, and is thus within the longitudinal length of the slider box main members. Because shroud 200 is positioned rearwardly of the front ends of main members 122, there is sufficient space for associated pneumatic lines (not shown) of pneumatic pin release/locking system 45 attached to manually operated pneumatic push/pull valve 80 to extend from the valve without extending outside of the longitudinal length of main members 122 of slider box 120, enabling the valve to be attached to the shroud with the pneumatic lines connected thereto via fittings 84A, 84B, and 84C during shipping. Because exemplary embodiment shroud 200 and all components of pneumatic pin release/locking system 45 are within the longitudinally length of main members 122 of slider box 120 when the shroud is mounted to base member 129, the slider box is provided with desirable shipping density, enabling more slider boxes to be shipped in/on the same container, trailer, or other transportation means at a time, thereby reducing shipping costs.

Furthermore, as the pneumatic lines (not shown) of pneumatic pin release/locking system 45 are already attached to manually operated pneumatic push/pull valve 80, which in turn is attached to shroud 200, once slider box 120 arrives at its destination, the shroud merely has to be detached from base member 129 via removal of the fasteners (not shown) disposed in each aligned opening 207 of flanges 206 and corresponding opening of the base member, and subsequently attached to flanges 127 of side walls 126 of front hanger 125A and/or the bottom of main member 122 of the slider box in the manner described above, to prepare the valve, and thus pneumatic pin release/locking system 45 for use, thereby decreasing assembly time of the slider box after shipping and reducing vehicle downtime. Thus, exemplary embodiment shroud 200 includes structure that enables the shroud to be temporarily attached to slider box 120 during shipping in a manner that provides the slider box with desirable shipping density, while allowing push/pull valve 80 with attached pneumatic lines (not shown) of pneumatic pin release/locking system 45 to be mounted to the shroud, thereby reducing shipping costs, as well as decreasing assembly time of the slider box after shipping and reducing vehicle downtime.

Thus, exemplary embodiment shroud for a manually operated valve of a pin release/locking system of a heavy-duty vehicle moveable subframe 200 of the disclosed subject matter provides structure that is attachable to a moveable subframe of the heavy-duty vehicle, enables mounting of the manually operated valve within an interior space of the shroud and includes structure that substantially encloses the valve when attached to the moveable subframe, thereby protecting the valve and associated components of the pin release/locking system from damage from road hazards potentially encountered during vehicle operation. Exemplary embodiment shroud 200 includes structure that also provides clearance for a forward mounted down-stop employed in some axle/suspension systems, as well as provides a safety barrier between an operator and components of the forward mounted down-stop and valve and/or moveable subframe during operation of the valve. In addition, exemplary embodiment shroud 200 includes structure that enables it to be temporarily mounted to the moveable subframe at a location that provides the moveable subframe with desirable shipping density, such as temporary mounting to a base member or cross-member of the heavy-duty vehicle moveable subframe, with the manually operated valve and associated components of the pin release/locking system attached, thereby decreasing shipping cost, as well as decreasing assembly time of the moveable subframe after shipping and reducing vehicle downtime.

It is contemplated that exemplary embodiment shroud 200 of the disclosed subject matter could be utilized on moveable subframes with different configurations and structure than slider boxes 20, 120 shown and described above, without affecting the over concept or operation of the disclosed subject matter. It is further contemplated that exemplary embodiment shroud 200 could have other sizes, shapes, and be formed from other materials than those shown and described without affecting the overall concept or operation of the disclosed subject matter. It is also contemplated that exemplary embodiment shroud 200 could be utilized to mount and house manually operated valves with different structures and functionality than manually operated pneumatic push/pull valve 80 and/or for different pin release/locking systems for moveable subframes than pneumatic pin release/locking system 45 shown and described without affecting the overall concept or operation of the disclosed subject matter.

It is further contemplated that exemplary embodiment shroud 200 could be utilized to mount other heavy-duty vehicle components within interior space 220 than push/pull valve 80 to substantially enclose and protect the components, such as pneumatic valves for various systems of the heavy-duty vehicle, electronic transmission/communication devices, load scales, bypass valves for automatic air spring dump, height control valves, and the like, and whether driver-interfaceable or not, without affecting the overall concept or operation of the disclosed subject matter. It is further contemplated that exemplary embodiment shroud 200 could be utilized with heavy-duty vehicle frames other than moveable subframes, such as heavy-duty vehicle primary frames, without affecting the overall concept or operation of the disclosed subject matter. For example, exemplary embodiment shroud 200 could be attached to a hanger of a primary frame and mount a heavy-duty vehicle component other than push/pull valve 80 in a heavy-duty vehicle that does not employ a moveable subframe without affecting the overall concept or operation of the disclosed subject matter. It is also contemplated that other heavy-duty vehicle components could be attached to exemplary embodiment shroud 200 within interior space 220 while push/pull valve 80 or a different heavy-duty vehicle component is also attached to the shroud without affecting the overall concept or operation of the disclosed subject matter. It is further contemplated that exemplary embodiment shroud 200 could be attached to a heavy-duty vehicle frame adjacent hangers at locations other than a driver-side hanger that connects the front-most axle/suspension system to the frame in trailing arm axle/suspension systems, such as a front-most passenger-side hanger or a hanger that connects the rear-most axle/suspension system to the frame in leading arm axle/suspension systems without affecting the overall concept or operation of the disclosed subject matter. It is further contemplated that exemplary embodiment shroud 200 could be attached to a heavy-duty vehicle frame adjacent a hanger without any components mounted to the shroud within interior space 220, to provide a safety barrier between a vehicle operator and components of a forward mounted down-stop and the hanger in heavy-duty vehicles that employ such down-stops without affecting the overall concept or operation of the disclosed subject matter. In addition, a heavy-duty vehicle frame could have more than one exemplary embodiment shroud 200 attached to the frame adjacent respective hangers for mounting respective heavy-duty vehicle components and/or providing a safety barrier between a vehicle operator and components of forward mounted down-stops and the hangers in heavy-duty vehicles that employ such down-stops. It is further contemplated that exemplary embodiment shroud 200 of the disclosed subject matter could be utilized with axle/suspension systems with different configurations and components that those shown and described, such as those that do not employ forward mounted down-stops, without affecting the overall concept or operation of the disclosed subject matter. It is to be further understood that exemplary embodiment shroud 200 could be temporarily mounted to slider box 120 during shipping on other components of the slider box than base member 129, at other locations on the base member, and/or in different positions than those shown and described, without affecting the overall concept or operation of the disclosed subject matter.

Accordingly, the shroud for a heavy-duty vehicle component of the disclosed subject matter is simplified, provides an effective, safe, inexpensive and efficient structure and method which achieves all the enumerated objectives, provides for eliminating difficulties encountered with prior art slider pin assemblies, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the disclosed subject matter is by way of example, and the scope of the invention is not limited to the exact details shown or described.

Having now described the features, discoveries and principles of a shroud for a heavy-duty vehicle component of the disclosed subject matter, the manner in which the shroud is installed and used, the characteristics of the construction, arrangement and method steps, and the advantageous, new and useful results obtained; the new and useful structures, devices, elements, arrangements, process, parts and combinations are set forth in the appended claims.

What is claimed is:

1. A shroud for a heavy-duty vehicle component comprising:
a front wall and a pair of side walls spaced apart from and rigidly connected to said front wall, said side walls and the front wall forming a hollow interior space within said shroud, the shroud being removably attached to a heavy-duty vehicle frame at a selected location; and
said component being mounted on at least one of said front wall and said side walls within said interior space, said shroud substantially enclosing the component when the shroud is mounted at said selected location on said heavy-duty vehicle frame.

2. The shroud for a heavy-duty vehicle component of claim 1, wherein said component is positioned within said interior space at a location that provides sufficient clearance for components of a forward mounted down-stop attached to an axle/suspension system depending from said heavy-duty vehicle frame.

3. The shroud for a heavy-duty vehicle component of claim 1, further comprising a top wall, said top wall being rigidly connected to said front wall and said side walls and forming said hollow interior space with the front wall and the side walls, wherein said component is mounted on at least one of the top wall, said front wall, and said side walls.

4. The shroud for a heavy-duty vehicle component of claim 2, wherein said component is attached to a top portion of said front wall to provide sufficient clearance for components of said forward mounted down-stop.

5. The shroud for a heavy-duty vehicle component of claim 1, wherein said heavy-duty vehicle frame is a moveable subframe.

6. The shroud for a heavy-duty vehicle component of claim 1, wherein said front wall and said pair of side walls are integrally formed as one-piece.

7. The shroud for a heavy-duty vehicle component of claim 3, wherein said front wall, said pair of side walls, and said top wall are integrally formed as one-piece.

8. The shroud for a heavy-duty vehicle component of claim 1, wherein said shroud is formed of laser cut sheet metal or stamped sheet metal.

9. The shroud for a heavy-duty vehicle component of claim 1, further comprising a pair of flanges, each one of said flanges being rigidly connected to a respective one of said side walls, said shroud being removably connected to said selected location of said heavy-duty vehicle frame by the flanges.

10. The shroud for a heavy-duty vehicle component of claim 9, wherein said selected location of said heavy-duty vehicle frame is a hanger.

11. The shroud for a heavy-duty vehicle component of claim 3, wherein said shroud is connected to at least one of a main member and a hanger of said heavy-duty vehicle frame.

12. The shroud for a heavy-duty vehicle component of claim 1, wherein said component is a valve of a pin release/locking system and said heavy-duty vehicle frame is a moveable subframe, said shroud being formed with an opening to provide access for manual operation of the valve.

13. The shroud for a heavy-duty vehicle component of claim 12, wherein said valve is a manually operated pneumatic push/pull valve.

14. The shroud for a heavy-duty vehicle component of claim 12, wherein one of said side walls is formed with an access opening to provide access for manual operation of said valve.

15. The shroud for a heavy-duty vehicle component of claim 14, wherein said side wall opposite the side wall formed with said access opening includes an opening that enables passage of lines of said pin release/locking system connected to said valve.

16. The shroud for a heavy-duty vehicle component of claim 1, wherein said shroud has a downwardly extending wedge shape.

17. The shroud for a heavy-duty vehicle component of claim 16, wherein said front wall includes a top portion and a bottom portion, said bottom portion extending angularly downwardly from said top portion and said side walls tapering from the top to the bottom of the side walls to provide said shroud with said downwardly extending wedge shape.

18. The shroud for a heavy-duty vehicle component of claim 1, wherein said heavy-duty vehicle frame is a moveable subframe, said shroud being removably connected to a base member of said moveable subframe for temporary mounting during shipping, said shroud being within a longitudinal length of main members of the moveable subframe to provide said moveable subframe with desirable shipping density.

19. The shroud for a heavy-duty vehicle component of claim 18, wherein said heavy-duty vehicle component is a valve of a pin release/locking system, one or more pneumatic lines of said pin release/locking system being connected to said valve when the valve is removably connected to said base member for temporary mounting during shipping.

20. The shroud for a heavy-duty vehicle component of claim 18, wherein said side walls of said shroud are formed with flanges, said shroud being removably connected to said base member via the flanges.

21. The shroud for a heavy-duty vehicle component of claim 1, wherein said shroud isolates access to components of a forward mounted down-stop attached to an axle/suspension system depending from said heavy-duty vehicle frame when said shroud is mounted at said selected location on the heavy-duty vehicle frame.

22. The shroud for a heavy-duty vehicle component of claim 1, wherein said component is a member of the group consisting of a pneumatic valve for a heavy-duty vehicle, an electronic transmission/communication device, a load scale, a bypass valve for automatic air spring dump, and a height control valve.
